(19) United States
(12) Patent Application Publication
(10) Pub. No.: US 2012/0124652 A1
(43) Pub. Date: May 17, 2012

(54) SYNCHRONIZATION APPARATUS AND METHOD

(75) Inventors: Eun-Jeong CHOI, Daejeon (KR); Jeun-Woo LEE, Daejeon (KR)

(73) Assignee: Electronics and Telecommunications Research Institute, Daejeon (KR)

(21) Appl. No.: 13/294,767

(22) Filed: Nov. 11, 2011

(30) Foreign Application Priority Data
Nov. 17, 2010 (KR) 10-2010-0114610

(51) Int. Cl. G06F 15/16; H04L 9/32

(52) U.S. Cl. 726/5; 709/248

(57) ABSTRACT

Disclosed herein is a synchronization apparatus and method. The synchronization apparatus includes a server synchronization determination unit for determining whether synchronization with a server is possible. A device search unit searches for a communication-enabled neighboring device if it is determined that synchronization with the server is impossible. A multi-hop synchronization processing unit transmits synchronous data to the neighboring device, thus enabling synchronization with the server via the neighboring device. In the synchronization method, whether synchronization with a server is possible is determined. If it is determined that synchronization with the server is impossible, a communication-enabled neighboring device is searched for. Synchronous data is transmitted to the neighboring device, thus enabling synchronization with the server via the neighboring device.

### CROSS REFERENCE TO RELATED APPLICATION

This application claims the benefit of Korean Patent Application No. 10-2010-0114610, filed on Nov. 17, 2010, which is hereby incorporated by reference in its entirety into this application.

### BACKGROUND OF THE INVENTION

1. Technical Field

The present invention relates generally to a synchronization apparatus and method and, more particularly, to a synchronization apparatus and method, which determine whether synchronization with a server is possible, and if it is determined that synchronization is impossible, it searches for a communication-enabled neighboring device and performs synchronization with the server via the neighboring device, thus enabling content to be synchronized without requiring the intervention of the server.

2. Description of the Related Art

Representative synchronization services that are currently being provided include synchronization technologies used in Funambol developed based on an international standard synchronization protocol (Synchronization Markup Language; SyncML), Microsoft ActiveSync, and MobileMe service based on an Apple-made protocol. All of these synchronization services operate based on data synchronization between terminals and a synchronization server.

However, there are several problems with such conventional synchronization service technology.

First, there is a disadvantage in that when a connection to the server is interrupted, the data of a terminal cannot be synchronized with the server. Since the conventional synchronization service technology performs data synchronization through the intervention of the server, the terminals that have been disconnected from the server cannot synchronize modified or changed data with the server and other terminals even if data has been modified or changed.

Second, there is a problem in that it is impossible to preserve data when a terminal is lost or data is damaged in the state of having not synchronized with the server. For example, when data in a specific terminal is modified or changed, and the specific terminal is lost or the data is damaged, the modified or changed data, occurring after the previous synchronization has been performed, cannot be preserved.

Third, when data generated by a single terminal is intended to be used by another terminal, the use of the data cannot be performed in the state in which synchronization is not performed with the server. Since conventional synchronization services are provided through the intervention of the server, it is difficult to share data between terminals without the intervention of the server.

All of these problems are caused because synchronization between terminals is performed through the intervention of the server in such a way that pieces of data changed by various terminals are individually synchronized with the server. That is, since the server must intervene for data to be shared between terminals, disconnection from the server makes it difficult to share content with other terminals.

### SUMMARY OF THE INVENTION

An object of the present invention is to provide a synchronization apparatus and method, which determine whether synchronization with a server is possible, and if it is determined that synchronization is impossible, search for a communication-enabled neighboring device and perform synchronization with the server via the neighboring device, thus enabling content to be synchronized without requiring the intervention of the server.

In accordance with an aspect of the present invention, there is provided a synchronization apparatus, including a server synchronization determination unit for determining whether synchronization with a server is possible; a device search unit for searching for a communication-enabled neighboring device if it is determined that synchronization with the server is impossible; and a multi-hop synchronization processing unit for transmitting synchronous data to the neighboring device, thus enabling synchronization with the server via the neighboring device.

Preferably, the synchronization apparatus may further include an authentication unit for authenticating the neighboring device found by the device search unit.

In accordance with another aspect of the present invention, there is provided a synchronization method, including determining whether synchronization with a server is possible; if it is determined that synchronization with the server is impossible, searching for a communication-enabled neighboring device; and transmitting synchronous data to the neighboring device, thus enabling synchronization with the server via the neighboring device.

Preferably, the synchronization method may further include authenticating the neighboring device found at the searching.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing a synchronization apparatus according to an embodiment of the present invention;

FIG. 2 is a flowchart showing a synchronization method according to an embodiment of the present invention;

FIG. 3 is a block diagram showing the configuration of a network in which the synchronization apparatus and method according to the embodiment of the present invention can be implemented;

FIG. 4 is a diagram illustrating an embodiment of the configuration of the network in which the synchronization apparatus and method according to the embodiment of the present invention can be implemented; and

FIG. 5 is a block diagram showing an example in which the synchronization apparatus and method according to the embodiment of the present invention are applied to personal cloud computing.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

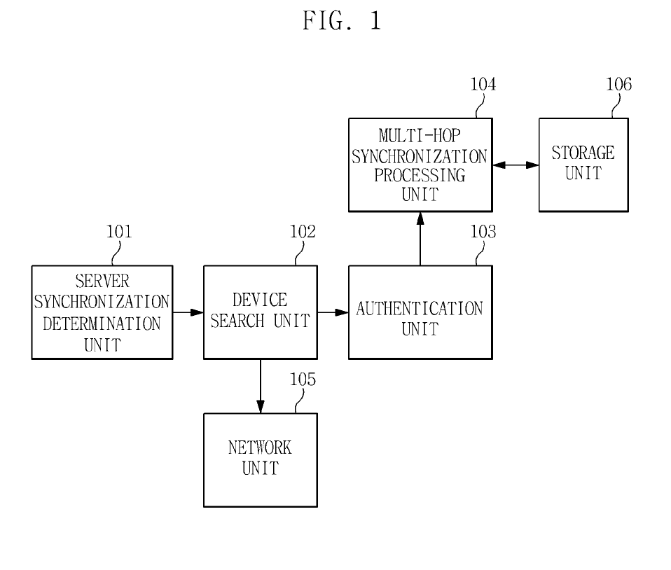

FIG. 1 is a block diagram schematically showing a synchronization apparatus according to an embodiment of the present invention.

Referring to FIG. 1, a synchronization apparatus according to an embodiment of the present invention may include a server synchronization determination unit 101, a device search unit 102, an authentication unit 103, a multi-hop synchronization processing unit 104, a network unit 105, and a storage unit 106. As shown in FIG. 1, the synchronization apparatus of FIG. 1 is configured in accordance with the embodiment of the present invention. All blocks shown in FIG. 1 are not essential components, and some blocks may be added, changed or deleted in other embodiments. For example, in another embodiment, the synchronization apparatus may be configured without using one or more of the authentication unit 103, the network unit 105 and the storage unit 106. In a further embodiment, the synchronization apparatus may be configured without using all of the authentication unit 103, the network unit 105 and the storage unit 106.

The synchronization apparatus according to the embodiment of the present invention may be a device, such as a mobile phone, a Personal Computer (PC), or a television that is capable of performing communication on a network, or may be included in such a device.

The server synchronization determination unit 101 is a unit for determining whether the synchronization apparatus of the embodiment of the present invention can be synchronized with a server. For example, when content is created or modified by a user on the synchronization apparatus, this content can be set to synchronous data, and the server synchronization determination unit 101 determines whether synchronization with the server is possible so as to synchronize such synchronous data.

The device search unit 102 is a unit for searching for a communication-enabled neighboring device if it is determined that synchronization with the server is not possible. Here, the neighboring device may be a device such as a mobile phone, a PC or a television, which is capable of performing communication on the network, as in the case of the synchronization apparatus according to the embodiment of the present invention. Further, the neighboring device may be implemented as the same device as the synchronization apparatus.

The device search unit 102 may send a message to search for any communication-enabled neighboring device, and when a response to the message is received from a neighboring device which received the message, may send the results of the search for the neighboring device to the authentication unit 103.

The authentication unit 103 is a unit for authenticating the neighboring device found by the device search unit 102. The synchronization apparatus according to the embodiment of the present invention may perform synchronization only with devices that have been successfully authenticated rather than all of neighboring devices. Therefore, the authentication unit 103 functions to authenticate whether the device found by the device search unit 102 is a device eligible for synchronization. In this case, the authentication by the authentication unit 103 may be performed using the ID and password of the user or the unique number of the device.

The multi-hop synchronization processing unit 104 is a unit for transmitting the synchronous data to the neighboring device and performing synchronization with the server via the neighboring device. In an embodiment, the multi-hop synchronization processing unit 104 transmits the synchronous data only to the neighboring device authenticated by the authentication unit 103, thus enabling synchronization to be performed without the intervention of the server.

The network unit 105 is configured to find a network over which communication is possible and to connect the found network to the synchronization apparatus if the synchronization apparatus cannot be synchronized with the server. In an embodiment, when the network unit 105 searches for a network over which communication is possible, the device search unit 102 can search for a communication-enabled neighboring device over the found network. In this case, the network over which communication is possible may be at least one selected from the group consisting of a Bluetooth network, a Zigbee network, a beacon network, a pseudo-satellite (pseudolite) network, a Local Area Network (LAN), a Wireless Broadband (WiBro) network, an infrared network, an ultrasonic network, a wireless Universal Serial Bus (USB) network, a Radio Frequency Identification (RFID) network, and an active RFID network

The storage unit 106 may store the synchronous data. The storage unit 106 may store the synchronous data, that is, content set by the user on the synchronization apparatus, so that when the multi-hop synchronization processing unit 104 subsequently performs synchronization processing, the stored synchronous data may be used.

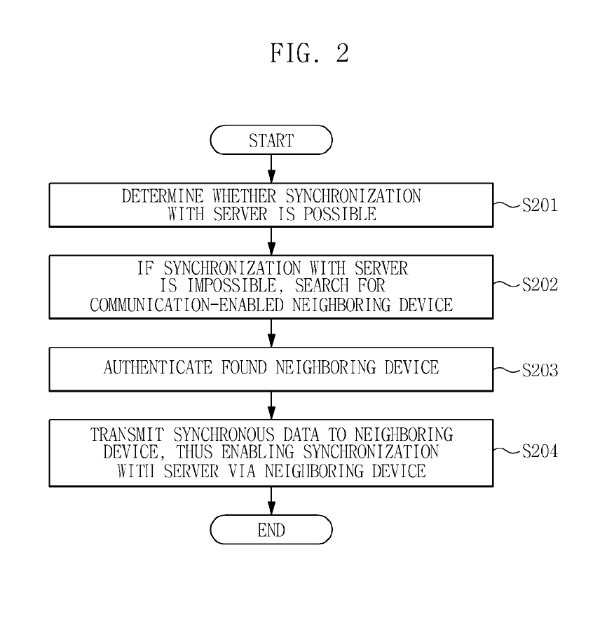

FIG. 2 is a flowchart showing a synchronization method according to an embodiment of the present invention.

Referring to FIG. 2, when the synchronization method according to the embodiment of the present invention is initiated, whether synchronization with a server is possible is determined at step S201. For example, when content is created or modified by the user, the created or modified content may be set to synchronous data. In order to synchronize such synchronous data, whether synchronization with the server is possible is determined.

If it is determined that synchronization with the server is impossible, a communication-enabled neighboring device is searched for at step S202. Here, the neighboring device may be a device, such as a mobile phone, a PC or television that is capable of performing communication on the network

After the communication-enabled neighboring device is found as a result of the search at step S202, the found neighboring device is authenticated at step S203. In this case, authentication may be performed using the ID and password of a user, or the unique number of the device.

After such an authentication step S203 has been performed, the synchronous data may be transmitted to the neighboring device, so that synchronization with the server is performed via the neighboring device at step S204.

Although not shown in FIG. 2, in another embodiment, the synchronization method may further include the step of, if it is determined that the synchronization of the synchronization apparatus with the server is impossible, finding a network over which communication is possible and connecting the found network to the synchronization apparatus. In an embodiment, when a network over which communication is possible is found, the communication-enabled neighboring device can be searched for over the found network at step S202. In this case, the network over which communication is possible may be at least one selected from the group consisting of a Bluetooth network, a Zigbee network, a beacon network, a pseudo-satellite (pseudolite) network, a LAN, a WiBro network, an infrared network, an ultrasonic network, a wireless USB network, RFID network, and an active RFID network.

Further, in a further embodiment, the synchronization method may further include the step of storing the synchronous data. In this way, the synchronous data, that is, the content set by the user on the synchronization apparatus, is stored, so that when synchronization processing is subsequently performed, the synchronous data may be used.

The above-described synchronization method has been described with reference to the flowchart presented in the drawing. Although the method has been shown and described using a series of blocks to simplify the description, the present invention is not limited to the sequence of the blocks. Some blocks may be performed in a sequence different from that shown and described in the present specification with respect to other blocks, or may be simultaneously performed. Furthermore, various different branches, flow paths and block sequences that achieve the same or similar results can be implemented. Further, all blocks shown in the drawings to implement the method described in the present specification may not be necessarily required.

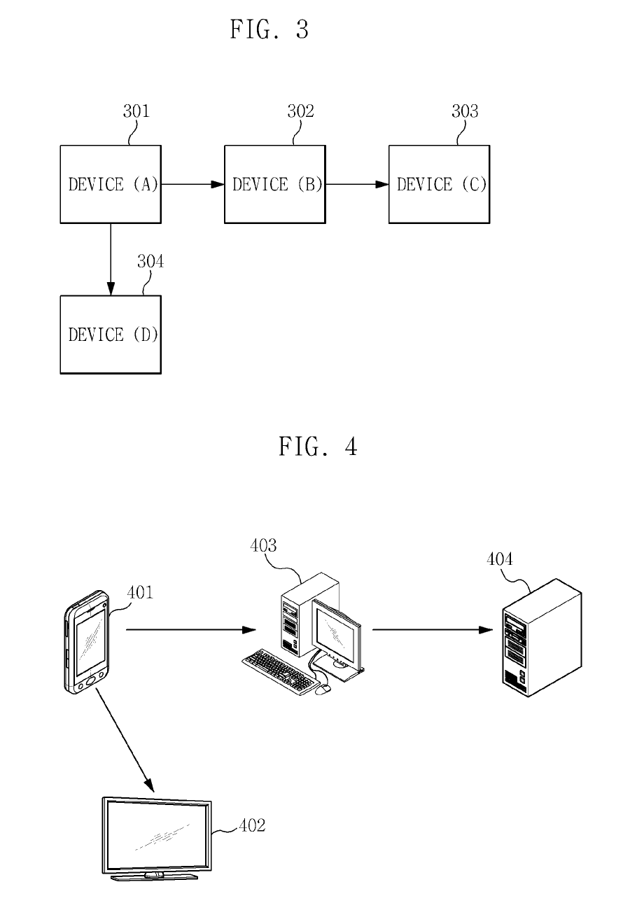

FIG. 3 is a block diagram showing the configuration of a network in which the synchronization apparatus and method according to an embodiment of the present invention can be implemented.

FIG. 3 illustrates an example of the configuration of a network in which the synchronization apparatus and method according to the embodiment of the present invention can be implemented, and those skilled in the art will appreciate that the network configuration may differ from that of FIG. 3.

Referring to FIG. 3, there are a plurality of devices 301, 302, 303 and 304 that can be used by a user. Depending on the characteristics of the networks of the respective devices, the device (A) 301 is connected to the device (B) 302 and the device (D) 304, but is not connected to the device (C) 303. Accordingly, it is impossible to automatically transfer content created or modified by the device (A) 301, that is, synchronous data, to the device (C) 303. However, if one device is capable of transferring the synchronous data to communication-enabled neighboring devices, the device (A) 301 can transfer the synchronous data to the device (C) 303 via the device (B) 302. In this case, the device (C) 303 may be a synchronization server in the synchronization apparatus and method according to the embodiment of the present invention, and the synchronization server may be a single device that can be used by the user.

That is, referring to FIG. 3, the same effect as that of direct synchronization can be obtained in such a way that the device (A) 301 is synchronized with the device (B) 302 without being directly connected to the server, that is, the device (C) 303, and the device (B) 302 is synchronized with the device (C) 303.

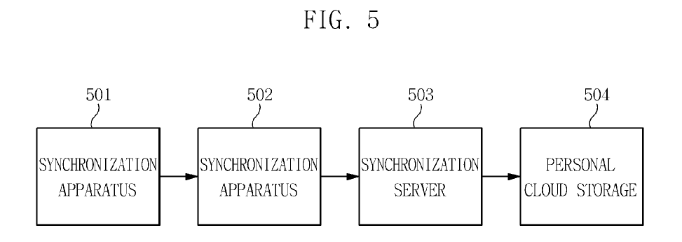

FIG. 4 is a diagram illustrating an embodiment of the configuration of the network in which the synchronization apparatus and method according to the embodiment of the present invention can be implemented.

FIG. 4 illustrates the embodiment by exemplifying a detailed device in order to provide a better understanding of the network configuration of FIG. 3. Similarly to FIG. 3, the embodiment of FIG. 4 may be shown as different embodiments.

Referring to FIG. 4, when a mobile phone 401 takes a picture, content is synchronized by the available device of a user. Based on this synchronization, the user can view the picture on a large screen such as that of a television 402 in the home, and can also edit the picture on a PC 403 in a study. In this time, source data is automatically stored on a server 404, so that convenience is improved. That is, in FIG. 4, the mobile phone 401 may perform synchronization via the PC 403 instead of being directly connected to the server 404 to perform synchronization.

FIG. 5 is a block diagram showing an example in which the synchronization apparatus and method according to the present embodiment of the present invention are applied to personal cloud computing.

In personal cloud computing, since the storage and processing of data, the use of a network and content, etc. are performed by a server rather than the user's device, that is, the user's terminal, the synchronization of data is important. Therefore, the synchronization apparatus and method according to the embodiment of the present invention can be usefully utilized in the case where, in personal cloud computing, the server becomes unavailable or connection to the server is made impossible.

Referring to FIG. 5, an embodiment in which the data of a terminal is synchronized with a personal cloud server is depicted. In this embodiment, synchronization apparatuses 501 and 502 according to the embodiment of the present invention are connected to each other so that they are able to communicate with each other. In this regard, when the synchronization apparatus 501 cannot be connected to a synchronization server 503, it finds an available synchronization apparatus 502 (a neighboring device) and then transmits synchronous data to the available synchronization apparatus 502. The synchronization apparatus 502 may be connected to the synchronization server 503, and then store the synchronous data in personal cloud storage 504.

Through the above-described procedure, a relevant terminal can be synchronized with a personal cloud server in personal cloud computing.

In accordance with an aspect of the present invention, there can be provided a synchronization apparatus and method, which determine whether synchronization with a server is possible, and if it is determined that synchronization is impossible, search for a communication-enabled neighboring device and perform synchronization with the server via the neighboring device, thus enabling content to be synchronized without requiring the intervention of the server. Further, the synchronization apparatus and method in accordance with another aspect of the present invention can be applied to technology for data synchronization between terminals and a personal cloud server.

Although specific embodiments of the present invention have been illustrated and described, it is apparent to those skilled in the art that the technical spirit of the present invention is not limited by the attached drawings and the above description, and various modifications and changes are possible without departing from the spirit and scope of the present invention. It should be understood that these modifications are included in the claims of the present invention without departing from the spirit of the invention.

What is claimed is:

1. A synchronization apparatus, comprising
a server synchronization determination unit for determining whether synchronization with a server is possible;
a device search unit for searching for a communication-enabled neighboring device if it is determined that synchronization with the server is impossible; and
a multi-hop synchronization processing unit for transmitting synchronous data to the neighboring device, thus enabling synchronization with the server via the neighboring device.

2. The synchronization apparatus of claim 1, further comprising an authentication unit for authenticating the neighboring device found by the device search unit.

3. The synchronization apparatus of claim 2, wherein the authentication unit performs authentication either using identification (ID) and password of a user or using a unique number of the device.

4. The synchronization apparatus of claim 1, further comprising a network unit for finding a network over which communication is possible and making a connection to the network over which communication is possible if it is determined that synchronization with the server is impossible,
wherein the device search unit searches for the communication-enabled neighboring device over the found network.

5. The synchronization apparatus of claim 4, wherein the network over which communication is possible is at least one selected from the group consisting of a Bluetooth network, a Zigbee network, a beacon network, a pseudo-satellite network, a Local Area Network (LAN), a Wireless Broadband (WiBro) network, an infrared network, an ultrasonic network, a wireless Universal Serial Bus (USB) network, a Radio Frequency Identification (RFID) network, and an active RFID network.

6. The synchronization apparatus of claim 1, further comprising a store unit for storing the synchronous data.

7. A synchronization method, comprising:
determining whether synchronization with a server is possible;
if it is determined that synchronization with the server is impossible, searching for a communication-enabled neighboring device; and
transmitting synchronous data to the neighboring device, thus enabling synchronization with the server via the neighboring device.

8. The synchronization method of claim 7, further comprising authenticating the neighboring device found at the searching.

9. The synchronization method of claim 8, wherein the authenticating comprises performing authentication either using identification (ID) and password of a user or using a unique number of the device.

10. The synchronization method of claim 7, further comprising finding a network over which communication is possible and making a connection to the network over which communication is possible if it is determined that synchronization with the server is impossible,
wherein the searching comprises searching for the communication-enabled neighboring device over the found network.

11. The synchronization method of claim 7, wherein the network over which communication is possible is at least one selected from the group consisting of a Bluetooth network, a Zigbee network, a beacon network, a pseudo-satellite network, a Local Area Network (LAN), a Wireless Broadband (WiBro) network, an infrared network, an ultrasonic network, a wireless Universal Serial Bus (USB) network, a Radio Frequency Identification (RFID) network, and an active RFID network

12. The synchronization method of claim 7, further comprising storing the synchronous data.
